(19) United States
(12) Patent Application Publication
(10) Pub. No.: US 2021/0218341 A1
(43) Pub. Date: Jul. 15, 2021

(54) MULTILEVEL STEP-UP INVERTER BASED ON DISTRIBUTED PASSIVE COMPONENTS

(71) Applicants: Yanchao Li, CULVER CITY, CA (US); Ruigang Li, LOS ANGELES, CA (US); Zheng Zuo, LOS ANGELES, CA (US)

(72) Inventors: Yanchao Li, CULVER CITY, CA (US); Ruigang Li, LOS ANGELES, CA (US); Zheng Zuo, LOS ANGELES, CA (US)

(73) Assignee: AZ Power, Inc, CULVER CITY, CA (US)

(21) Appl. No.: 17/150,961

(22) Filed: Jan. 15, 2021

Related U.S. Application Data
(60) Provisional application No. 62/961,671, filed on Jan. 15, 2020.

(51) Int. Cl. H02M 7/483; H02M 7/5387; H02M 1/08

(52) U.S. Cl. CPC H02M 7/483; H02M 2007/4835; H02M 1/083; H02M 7/53871

(57) ABSTRACT

A power converter may include a plurality of inductor banks; a plurality of capacitor banks; a plurality of switches, each switch having two power nodes and one control node that receives a control signal that maintains the switch in either ON state in which the circuit path between the first node and the second node are established, or OFF state in which the circuit path between the first node and the second node are eliminated; and a control logic that generates multiple signal combinations that are applied to the control nodes of the switches so that for each signal combination the power converter is configured to generate different voltage outputs. In one embodiment, the control logic generates control signals to cause zero current switching on each switch.

### CROSS-REFERENCE TO RELATED APPLICATIONS

This application claims priority under 35 U.S.C. § 119 (e) to U.S. Provisional Patent Application Ser. No. 62/961,671, filed on Jan. 15, 2020, the entire contents of which are hereby incorporated by reference.

### FIELD OF THE INVENTION

The present invention relates to DC-AC power converters, and more particularly to multilevel DC-AC power converters.

### BACKGROUND OF THE INVENTION

Power converters that convert DC voltage to AC voltage have very wide range of applications, such as electronic motor drive and renewable energy application. The conventional one-phase inverter is composed by two paralleled half-bridges. Similarly, the conventional three-phase inverter uses three paralleled half-bridges, and each half-bridge includes two switches that are connected in series.

A multilevel DC-AC power converter is different from the conventional two-level inverter. Multilevel inverters, such as flying capacitor multilevel inverter (FCMI) and diode clamped multilevel inverter (DCMI), use a constant input voltage to generate more than two different voltage levels at the output of each phase, whereas the conventional inverter can only generate two voltage levels at the phase output terminal.

### SUMMARY OF THE INVENTION

In one aspect, a power converter may include a plurality of capacitor bank, and each capacitor bank has respective first and second node that are connected to respective circuit nodes in a circuit; a plurality of inductor bank, and each inductor bank has respective first and second node that are connected to respective circuit nodes in a circuit; a plurality of switches, and each switch has two power nodes and one control nodes that receives a control signal that maintains the switch in either ON state in which the circuit path between the first node and the second node are established, or OFF state in which the circuit path between the first node and the second node are eliminated, and the first and second node that are connected to respective circuit nodes in a circuit; and a control logic that generates multiple signal combinations that are applied to the control nodes of the switches so that the device achieves different voltage output.

Particular embodiments of the subject matter described in the present invention can be implemented so as to realize one or more of the following advantages. For example, the device is configured to generate two voltage levels on the output of each phase leg. Therefore, the device can generate multiple voltage levels between every two phases in a one-phase or three-phase inverter system, which overcomes the weakness of the conventional two-level inverters that usually suffer from poor total harmonic distortion (THD) and high electromagnetic interference (EMI) issues. Furthermore, with the inductor banks and capacitor banks in the circuit, the converter can achieve the goal of zero current switching during the operation, which makes the converter great more advantageous than conventional multilevel converters in terms of EMI and efficiency.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates a circuit diagram of a 1-phase DC to AC converter topology in the present invention.

FIG. 2 illustrates the circuit diagram of half portion of the circuit shown in FIG. 1 in the present invention.

FIG. 3 illustrates the circuit diagram of the first sub-circuit of the circuit shown in FIG. 2 in the present invention.

FIG. 4 illustrates the circuit diagram of the second sub-circuit of the circuit shown in FIG. 2 in the present invention.

FIG. 5 illustrates the circuit diagram of the third sub-circuit of the circuit shown in FIG. 2 in the present invention.

FIG. 6 illustrates the circuit diagram of the active parts of the circuit shown in FIG. 1 when the converter's output equals to its input in the present invention.

FIG. 7 illustrates the waveform of the one-phase converter output voltage.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

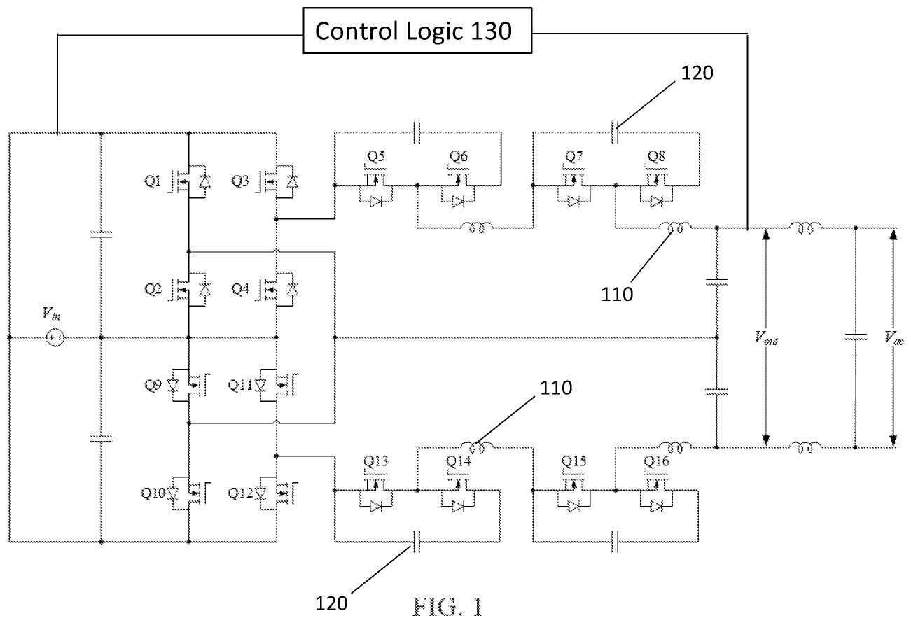

FIG. 1 is the circuit diagram of a one-phase DC to AC converter topology. This circuit is constructed on a circuit bearing structure, such as print circuit board (PCB).

In one embodiment, the circuit includes a plurality of inductor banks. Each bank may include at least one inductor 110, and has first and second nodes. In some embodiments, an inductor in an inductor bank may be the parasitic inductance of a circuit bearing structure. The circuit also includes a plurality of capacitor banks. Each bank may include at least one capacitor 120, and has first and second nodes. The circuit also includes a control logic 130 and at least one low pass filter with the first and second node that are connected to respective circuit nodes in a circuit.

In a further embodiment, the circuit may include a plurality of switches (Q1 to Q16) having respective first and second power nodes and a control node. The input of control signal maintains the switch in either ON state in which the circuit path between the first node and the second node are established, or OFF state in which the circuit path between the first node and the second node are eliminated. In FIG. 1, for example, the N-channel MOSFETs are used. However, any other types of switches can be also used in the present invention.

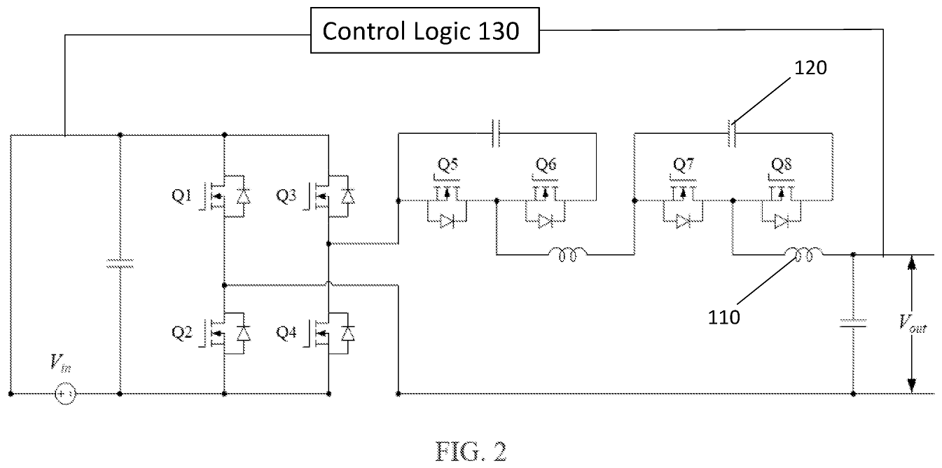

FIG. 2 is the circuit diagram of first half of the circuit shown in FIG. 1. The circuit shown in FIG. 1 can be divided into two groups, where the first group includes switches Q1 to Q8, and the second group includes switches Q9 to Q16. It is noted that the control signal generated by the control logic 130 are the same for the two groups. However, the combination of the control signals will not be applied to the two groups of circuits at the same time.

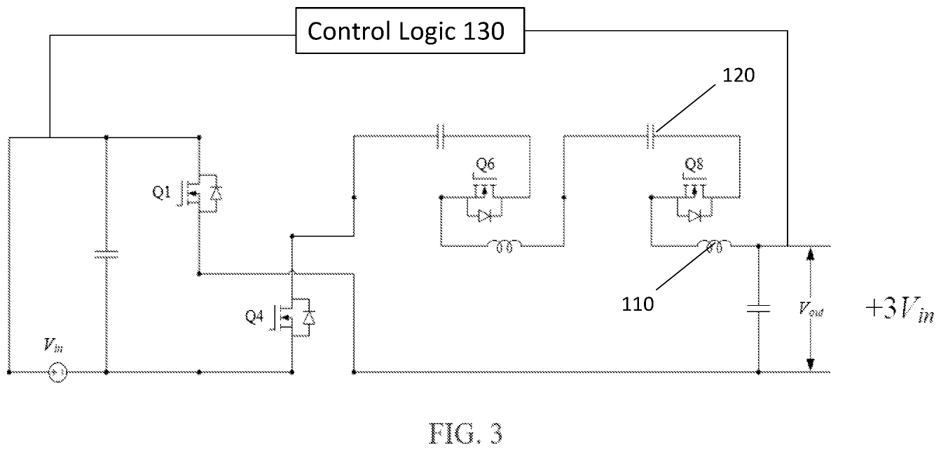

FIG. 3 is the circuit diagram of the first sub-circuit of the first half circuit shown in FIG. 2. When switches Q1, Q4, Q6 and Q8 are in the “on” state, all capacitor banks are in the circuit loop, charging or discharging.

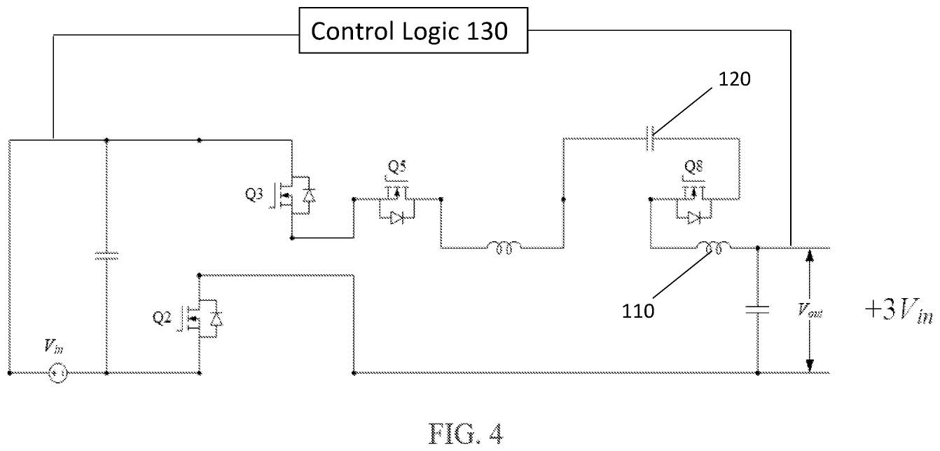

FIG. 4 is the circuit diagram of the second sub-circuit of the first half circuit shown in FIG. 2. When switches Q2, Q3, Q5 and Q8 are in the “on” state, one of the capacitor banks has been bypassed. In this situation, only one capacitor bank is not in the circuit loop, while the other capacitor banks are charging or discharging.

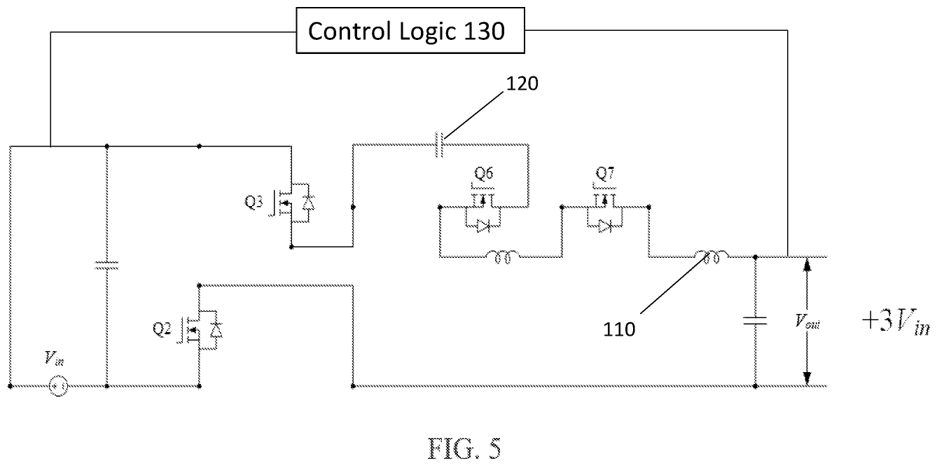

FIG. 5 is the circuit diagram of the third sub-circuit of the first half circuit shown in FIG. 2. When switches Q2, Q3, Q6 and Q7 are in “on” state, one of the capacitor banks has been bypassed, which is similar to the second sub-circuit. The capacitor bank in the circuit loop is charging/discharging, while the bypassed one is not.

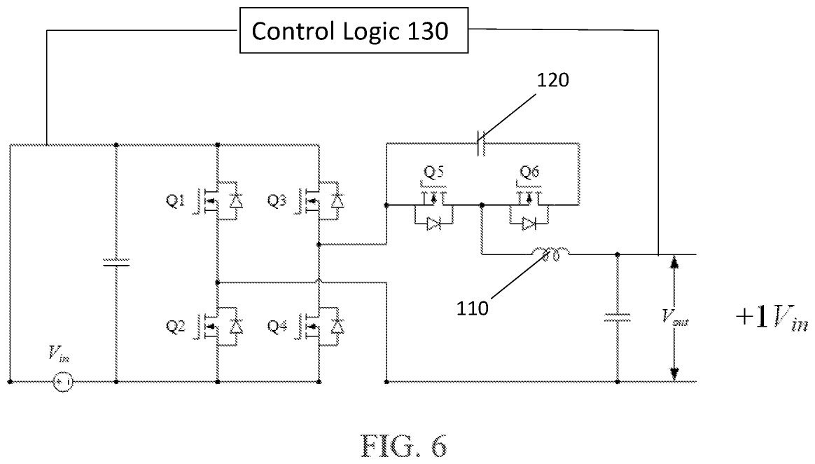

FIG. 6 is the circuit diagram of the active parts of the circuit shown in FIG. 1 when the converter's output equals to its input. In this case, there are only six switches that are turn on and turn off. The switch Q7 is always stays in “on” state and Q8 is kept “off”. This means when the magnitude of the converter's output is the same as its input, one of the capacitor banks is always bypassed.

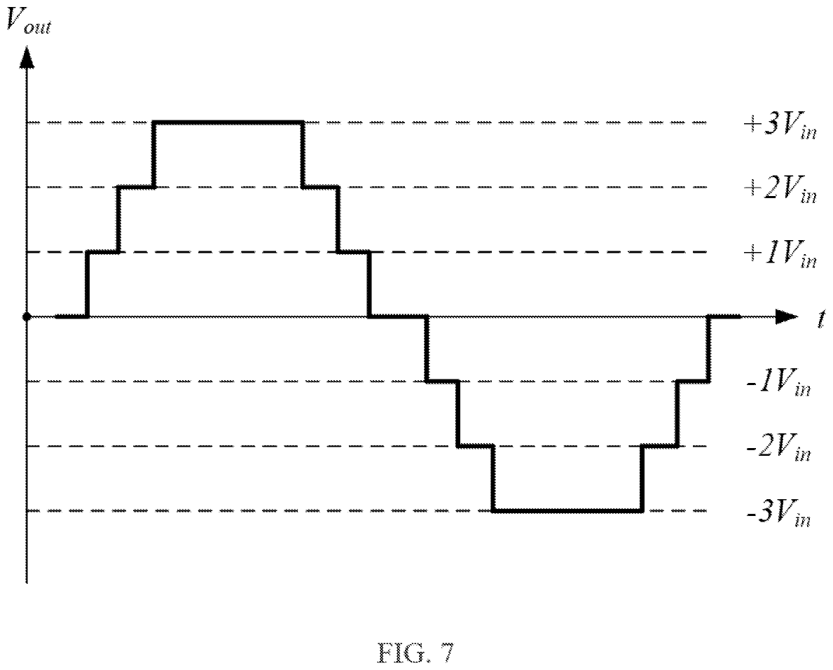

As discussed above, the control logic 130 generates different control signal combinations that are applied to the control node of the switch. In one embodiment, for the N-channel MOSFETs of FIG. 1, the control signals are applied to gate. FIG. 7 is the generated AC voltage waveform on the output nodes of a one-phase converter. In some embodiments, the control logic controls the switches to turn-on and turn-off at zero current, therefore the zero current switching is achieved. This control mechanism gives the lossless switching feature to the circuit.

In summary, the present invention relates to a multilevel inverter based on distributed passive components. The inverter may include multiple switches that are connected to the circuit nodes; multiple inductor banks that are connected to the non-ground circuit nodes; and multiple capacitor banks that are connected to the non-ground circuit nodes. The switches are controlled by a control logic that generates different control signals which are applied to the control nodes of the switches. With different control signal combinations, the converter can generate different voltage levels at the converter output. In addition, the control logic generates signals to ensure the switches to turn on and off at zero current.

Having described the invention by the description and illustrations above, it should be understood that these are exemplary of the invention and are not to be considered as limiting. Accordingly, the invention is not to be considered as limited by the foregoing description, but includes any equivalent.

What is claimed is:

1. A power converter comprising:
a plurality of inductor banks;
a plurality of capacitor banks;
a plurality of switches, each switch having two power nodes and one control node that receives a control signal that maintains the switch in either ON state in which the circuit path between the first node and the second node are established, or OFF state in which the circuit path between the first node and the second node are eliminated; and
a control logic that generates multiple signal combinations that are applied to the control nodes of the switches so that for each signal combination the power converter is configured to generate different voltage outputs.

2. The power converter of claim 1, wherein each inductor bank includes at least one inductor that have two nodes connected to respective circuit nodes in a circuit.

3. The power converter of claim 1, wherein each capacitor bank includes at least one capacitor that have two nodes connected to respective circuit nodes in a circuit.

4. The power converter of claim 1, wherein each first power node and each second power node of each switch is connected to a respective circuit node in the circuit.

5. The power converter of claim 1, wherein the control logic generates control signals to cause zero current switching on each switch.

6. The power converter of claim 1, wherein an inductor in an inductor bank is a parasitic inductance of a circuit bearing structure.

7. The power converter of claim 1, wherein said plurality of switches are MOSFETs; the first power nodes are drains, the second power nodes are sources, and the control nodes are gates.

8. The power converter of claim 1, wherein at least one circuit node connects with an input voltage and at least one circuit node generates an output voltage whose magnitude is higher than or same with the input voltage.
